(19) United States
(12) Patent Application Publication
(10) Pub. No.: US 2007/0217655 A1
(43) Pub. Date: Sep. 20, 2007

(54) Image detection device

(75) Inventor: Shinichirou Miyajima, Fukuoka (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/489,521

(22) Filed: Jul. 20, 2006

(30) Foreign Application Priority Data
Mar. 20, 2006 (JP) 2006-077556

(51) Int. Cl. G06K 9/00

(52) U.S. Cl. 382/103

(57) ABSTRACT

A device for detecting an image area from an image data that is inputted in series for each pixel is provided. The device includes a lateral direction edge detection portion for comparing pixel data of neighboring pixels in the lateral direction on one line of the image, a vertical direction detection portion for regarding pixels of edge addresses as a noted pixel and comparing pixel data of the noted pixel with that of a pixel one the next line neighboring the noted pixel so as to detect a pixel having a difference between the data within a predetermined range, an area address memory portion for storing an address of the detected pixel when the vertical direction detection portion detected that the difference is within a predetermined range, and an area extraction portion for extracting an area that satisfies a size condition stored in the area address memory portion.

### BACKGROUND OF THE INVENTION

1. Field of the Invention

The present invention relates to an image detection device for detecting a predetermined image area from a pixel data that is input in series for each pixel with respect to an image including a plurality of pixels arranged in the lateral direction and the vertical direction like a matrix.

2. Description of the Prior Art

Conventionally, an intruder or the like in a monitored area can be detected in accordance with images that are obtained by using a still picture camera or a video camera. For example, a plurality of images is obtained at a predetermined interval of time, and the images are compared so that changes among the images are analyzed for detecting an intruder or the like (see Japanese unexamined patent publication No. 2003-169321).

According to another conventional method, an image data in a monitored area is obtained continuously by a camera and are analyzed. An absolute value of a differential between the image obtained currently and the image obtained last time is calculated with respect to each pixel, and then the absolute value is compared with a preset threshold value so as to detect an intruder or the like (see Japanese unexamined patent publication No. 2004-128899)

In the above-mentioned conventional methods for detecting an intruder or the like or in other conventional methods for such as flood control monitoring in a dam or a river, face information of an arbitrary object is detected from images by a software process by using a CPU or a DSP so as to attain a purpose.

For example, an image data of an obtained image is stored in a memory temporarily, and the stored image data is retrieved from the memory by a software process, followed by another software process for analyzing to detect an object or the like. In this case, there are problems that the detection time is delayed because the detection is performed after obtaining the image and that a process load on the CPU or the DSP is large because of the software process.

This will be described more specifically as follows. For example, it is supposed that an image GJ1 as shown in FIG. 12(A) is obtained in a normal state in the case where an intruder into a building should be detected by monitoring an area around the building. Within the image GJ1, an image TR1 of an area to be monitored is obtained. Then, one frame after this image GJ1, an image GJ2 shown in FIG. 12(B) may be obtained, and an image TR2 of the area to be monitored may be obtained. A portion having a difference of luminance between the two images TR1 and TR2 is detected. If the number of portions having the difference of luminance between the first and the second frames is more than a predetermined number, the image including the portions is analyzed so as to determine whether there is an intruder or not.

If the determination is performed in accordance with only the number of detected portions, there is a possibility to detect other object that is not an intruder to be detected like an image TR3 shown in FIG. 12(C). In order to avoid this detection error, the detected portions are analyzed in detail so that a size of a detected object is calculated. If the calculated size has a predetermined value or larger, it is determined that the object has been detected. For example, a detected portion of an image TR2 shown in FIG. 12(D) has a predetermined size or more, so it is regarded as an intruder. On the contrary, a size of a detected portion of an image TR3 shown in FIG. 12(E) is smaller than a predetermined size, so it is not regarded as an intruder.

However, if such a detail analysis is performed from a first step, process quantity increases so that a load on a CPU or the like becomes too large. Therefore, it is necessary to perform a step-by-step process, in which an image TR of each frame is detected on a block basis with a decreased resolution at a first step, and then the resolution is increased for a detail process. Nevertheless, these processes are rather a large load as a whole on the CPU or the like. Therefore, it is necessary to increase the number of DSPs for enhancing a throughput or to perform distributed processing.

### SUMMARY OF THE INVENTION

An object of the present invention is to provide an image detection device that detects an object such as an intruder at a high speed, so that a load of a process that is performed after the detection by a CPU or the like can be reduced.

An image detection device according to one aspect of the present invention is a device for detecting a predetermined image area from an image data that is inputted in series for each pixel of an image made up of a plurality of pixels arranged in the lateral direction and the vertical direction like a matrix. The device includes a size condition memory portion for storing a size condition of the image area to be detected, a lateral direction edge detection portion for detecting an edge by comparing pixel data of neighboring pixels on one line in the lateral direction of the image, an edge address memory portion for storing an address of the detected edge, a vertical direction detection portion for regarding each pixel of the address stored in the edge address memory portion as a noted pixel, comparing a pixel data of the noted pixel with that of a pixel on the next line neighboring the noted pixel and detecting a pixel having a difference of the pixel data within a predetermined range, an area address memory portion for storing an address of the detected pixel as an area edge address when it is detected that the difference of the pixel data is within a predetermined range by the vertical direction detection portion, and an area extraction portion for extracting an area that satisfies the size condition stored in the size condition memory portion from an area address stored in the area address memory portion.

Preferably, the lateral direction edge detection portion regards one of pixels inputted in series as the noted pixel, compares the pixel data of the noted pixel with that of a pixel neighboring the noted pixel, and detects pixels at both ends of consecutive pixels having the difference within a predetermined range as the edge.

In addition, the vertical direction detection portion compares three pixels with each other, the three pixels including a pixel on the next line of the noted pixel at the same position in the lateral direction as the noted pixel and pixels on both sides of the pixel.

According to the present invention, a target of detection such as an intruder can be detect at high speed, so that a load on a process performed after that by a CPU or the like can be reduced.

### BRIEF DESCRIPTION OF THE DRAWINGS

FIG. 1 is a block diagram showing a general structure of a monitoring system according to the present invention.

FIG. 2 is a block diagram showing a structure of an image detection device.

FIG. 3 is a diagram showing a structure of an image data of one frame obtained from a camera.

FIG. 4 is a diagram showing an example of an image.

FIGS. 5(A) and 5(B) are diagrams showing an example of an intruder and an image area corresponding to the intruder.

FIG. 6 is a diagram showing an example of an image data.

FIG. 7 is a diagram showing an example of a pixel data that is stored temporarily in each portion of the image detection device.

FIGS. 8(A)-8(C) are diagrams showing an example of an image area that is detected by a vertical comparison portion.

FIG. 9 is a block diagram showing an example of a structure for detecting whether an edge of an area is a straight line or a curve.

FIG. 10 is a block diagram showing an example of a structure for determining a differential between frames of the edge of the area.

FIG. 11 is a block diagram showing an example of a structure for setting an area to be detected in an image.

FIGS. 12(A)-12(E) are diagrams for explaining a conventional method for detecting an image.

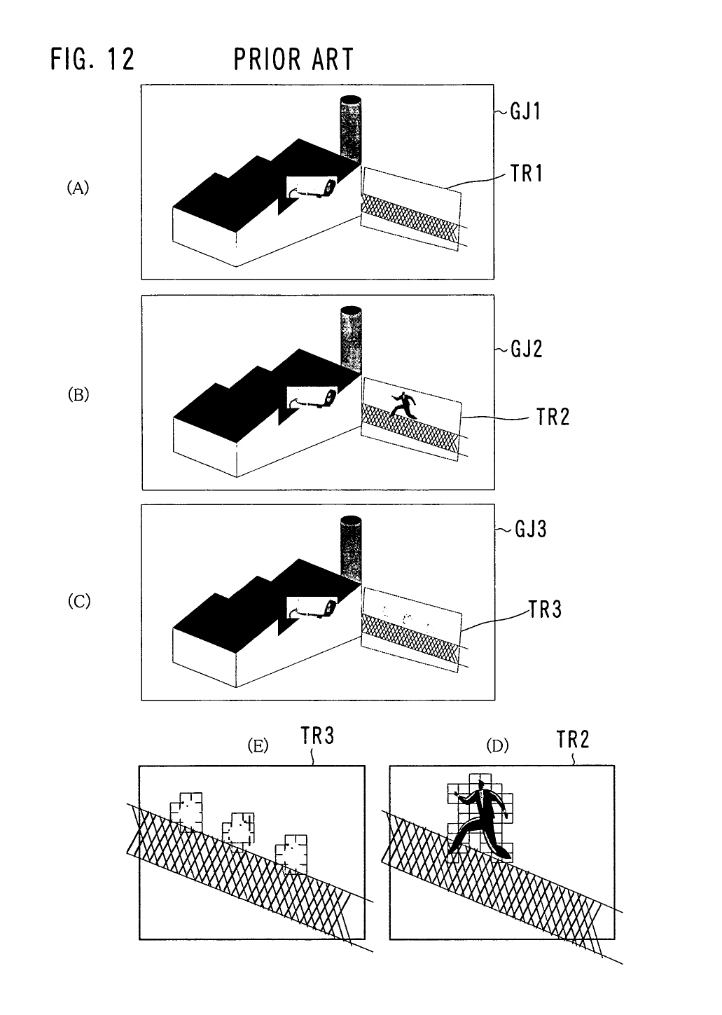

### DESCRIPTION OF THE PREFERRED EMBODIMENTS

The invention will now be described in detail with reference to the attached drawings.

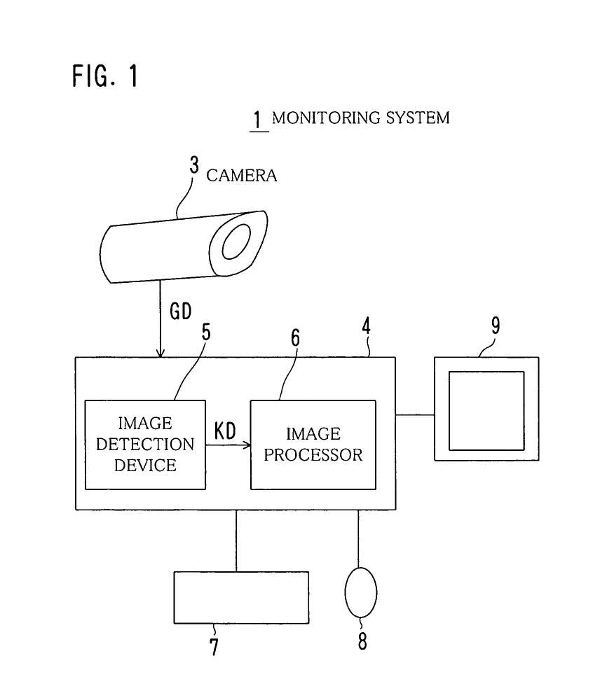

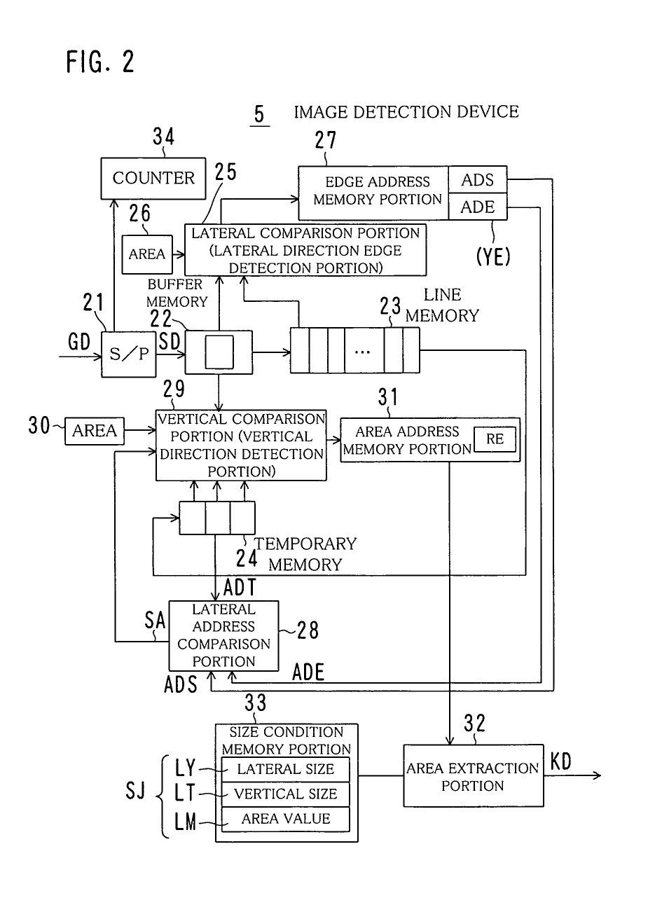

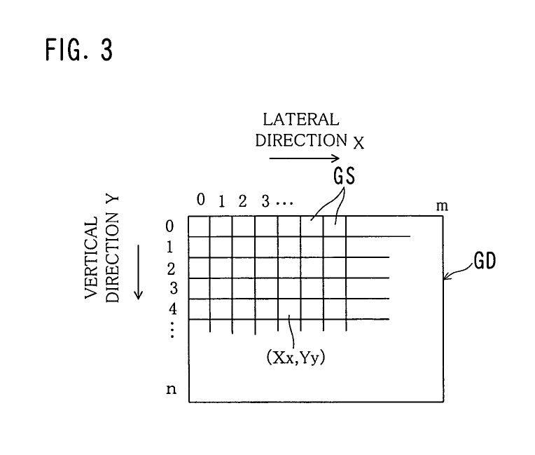

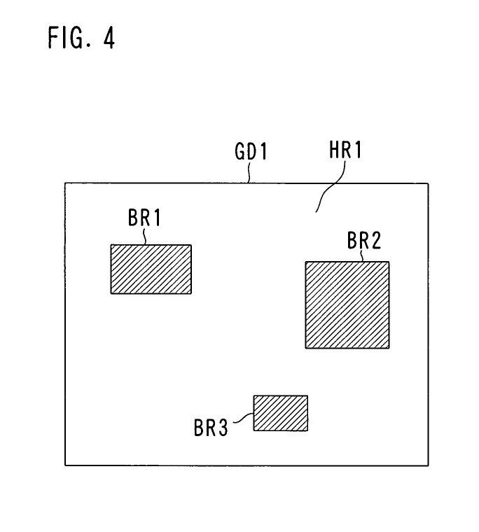

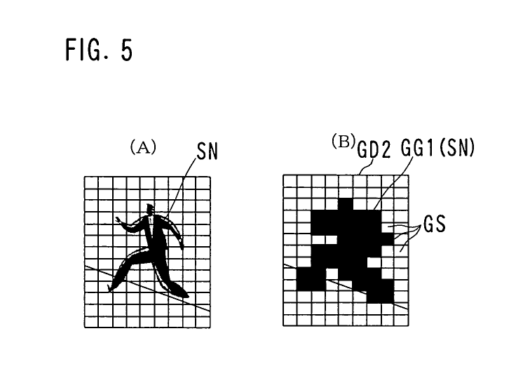

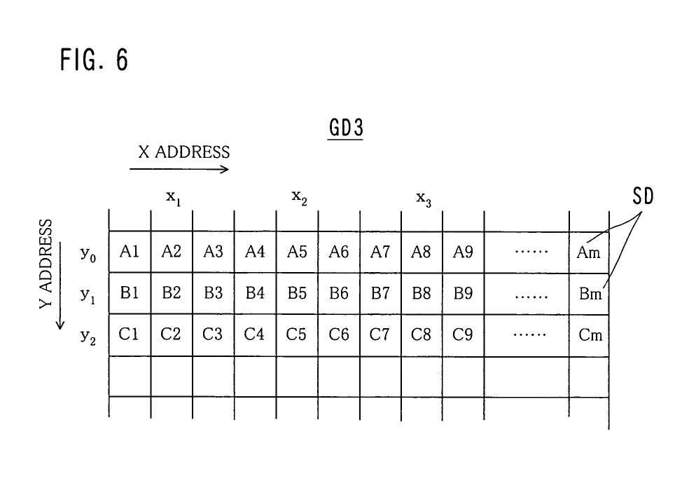

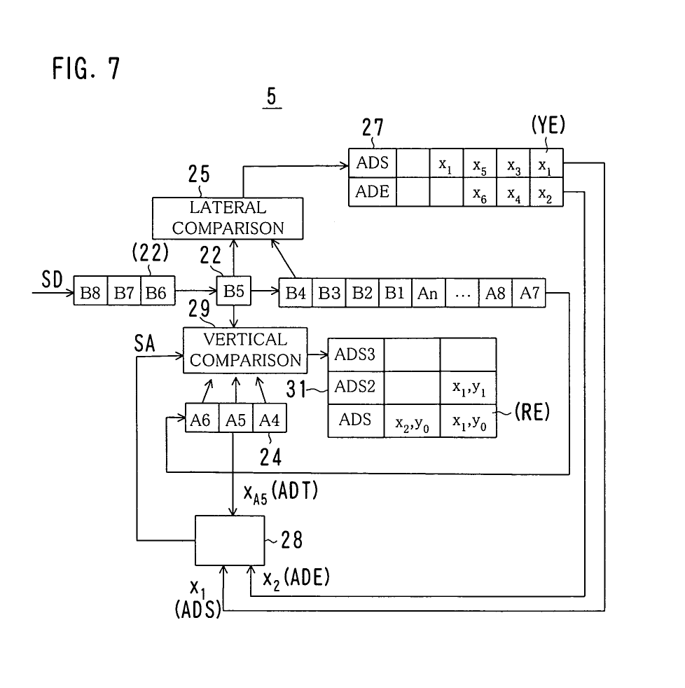

FIG. 1 is a block diagram showing a general structure of a monitoring system 1 according to the present invention, FIG. 2 is a block diagram showing a structure of an image detection device 5, FIG. 3 is a diagram showing a structure of an image data GD of one frame obtained from a camera 3, FIG. 4 is a diagram showing an example of an image GD1, FIGS. 5(A) and 5(B) are diagrams showing an example of an intruder SN and an image area GG1 corresponding to the intruder, FIG. 6 is a diagram showing an example of an image data GD3, and FIG. 7 is a diagram showing an example of a pixel data SD that is stored temporarily in each portion of the image detection device 5.

As shown in FIG. 1, the monitoring system 1 includes a camera 3, a monitoring processor 4, a keyboard 7, a mouse 8 and a display device 9.

The camera 3 is installed in a place to be monitored such as a factory, a dam or a river, and it takes a picture or an image in an area to be monitored so as to produce a pixel data SD. The camera 3 produces an image data GD of a predetermined size at a frame rate of 30 frames per second. Note that the pixel data SD may be transmitted via a cable or a network, a wireless communication or the like.

As shown in FIG. 3, the image data GD of one frame corresponds to an image in which m×n pixels are arranged like a matrix. More specifically, m pixels are arranged in the lateral direction (the main scanning direction, the line direction or the X direction), while n pixels are arranged in the vertical direction (the sub scanning direction or the Y direction). The upper left end in FIG. 3 is the origin (X0, Y0). Each row (line) extends from X0 to Xm, while each column extends from Y0 to Yn. An address of any pixel GS is represented by (Xx, Yy).

In this embodiment, the image data GD corresponds to a monochrome image, in which each pixel GS has a luminance value (luminance data) of eight bits (256 gradation levels). A luminance value of the darkest portion is “0”, while a luminance value of the brightest portion is “255”.

The camera 3 produces luminance values, i.e., the pixel data SD of each pixel GS in each frame in series from the upper left end pixel GS toward the right in the image data GD, i.e., from the left to the right on the first line, followed by the second line, the third line and finally the last line until the right end pixel GS. Although the pixel data SD is adapted to an 8-bit parallel output when the data is produced for each pixel GS as described above, it is possible to produce the 8 bit as a serial data (bit serial data). Note that an “image data” may be referred to as an “image”.

The monitoring processor 4 includes an image detection device 5 and an image processor 6. The image detection device 5 detects a predetermined image area GR from the image data GD that are supplied from the camera 3, and it supplies a detection result KD to the image processor 6. This will be described in detail below.

The image processor 6 analyzes the detection result KD supplied from the image detection device 5 and performs various processes for monitoring, which include determination whether an intruder exists or not, whether an abnormal state occurred or not and the like. Then, the image processor 6 produces a warning signal, if necessary.

The keyboard 7 and the mouse 8 are used for giving various instructions to the monitoring processor 4 or for entering a setting data. The display device 9 displays the image GD obtained by the camera 3, and it also displays an image, data or a message after being processed by the monitoring processor 4.

This monitoring processor 4 can be realized as a whole by using a computer. In this case, it is preferable to realize the image detection device 5 by using special purpose hardware. However, it is possible that a part of the image detection device 5 is realized by a process performed by a DSP or a CPU. In addition, it is possible to constitute the image detection device 5 as a unit that is independent of the image processor 6.

As shown in FIG. 2, the image detection device 5 is equipped with a serial to parallel conversion portion 21, a buffer memory 22, a line memory 23, a temporary memory 24, a lateral comparison portion (a lateral direction edge detection portion) 25, a lateral area setting portion 26, an edge address memory portion 27, a lateral address comparison portion 28, a vertical comparison portion (a vertical direction detection portion) 29, a vertical area setting portion 30, an area address memory portion 31, an area extraction portion 32, a size condition memory portion 33, a counter 34 and the like. In addition, a CPU or a DSP for controlling the entire device is also provided if necessary, though it is not illustrated.

The serial to parallel conversion portion 21 converts the image data GD that was entered as serial data into parallel data. Therefore, the serial to parallel conversion portion 21 produces data of eight bits (pixel data) SD indicating a luminance value of each pixel GS.

Note that if parallel data of eight bits are entered for each pixel, the serial to parallel conversion portion 21 becomes transparent to the data.

The buffer memory 22 temporarily stores appropriate pixels (e.g., one pixel) out of the pixel data SD supplied in series from the serial to parallel conversion portion 21. More specifically, the pixel data SD supplied from the serial to parallel conversion portion 21 passes through the buffer memory 22 and are sent to the line memory 23, and one pixel of data is stored temporarily in the buffer memory 22. Note that it is possible that the buffer memory 22 is adapted to store the pixel data SD for a plurality of pixels as buffering.

The line memory 23 is an FIFO memory for storing one line of image, and it delays the pixel data SD supplied via the buffer memory 22 by the time corresponding to one line. The pixel data SD sent out of the line memory 23 is supplied to the temporary memory 24.

The temporary memory 24 stores three pixels of the pixel data SD supplied from the line memory 23 in series. In this case, the center pixel of the three pixels corresponds to a pixel that has just been sent from the line memory 23, and pixels at both sides correspond to neighboring pixels of the center pixel. In other words, the center pixel corresponds to a pixel one line before the pixel stored in the buffer memory 22, and therefore X addresses of the pixels are identical to each other. Therefore, when an address ADT of the center pixel is represented by (Xx, Yy), addresses of the pixels at both sides thereof are represented by (Xx−1, Yy) and (Xx+1, Yy). An address ADM of one pixel stored in the buffer memory 22 is represented by (Xx, Yy+1). When new pixel data SD is entered in the temporary memory 24, previous pixel data SD before the three pixels is abandoned.

In the following description, “X” or “Y” may be omitted if intention of indicating an X address or a Y address is clearly understood.

The lateral comparison portion 25 compares pixel data SD of neighboring pixels GS on one line in the lateral direction of the image GD, so that an edge (the lateral direction edge) YE is detected. More specifically, one of pixels that were inputted sequentially and stored in the buffer memory 22 is regarded as a noted pixel, and a pixel data SD of the noted pixel is compared with that of a pixel neighboring the noted pixel. If the difference between them is within a predetermined range, pixels on both ends of the consecutive pixels are detected to be an edge YE.

More specifically, the lateral comparison portion 25 compares the pixel data SD of one pixel stored in the buffer memory 22 with the pixel data SD of one pixel stored at the end of the line memory 23. Then, the lateral comparison portion 25 checks whether or not a difference between them is within a predetermined range set in the lateral area setting portion 26. When a pixel having the difference that is within a predetermined range is found, it is regarded as a first pixel, and its address (a first address) is stored in the edge address memory portion 27. After that, if there are successive pixels having the difference that is within a predetermined range, their addresses are not stored. When a pixel having the difference beyond the predetermined range appears, it is regarded as an end pixel, and its address (an end address) is stored in the edge address memory portion 27.

Note that the end pixel is a last pixel when pixels having the difference within a predetermined range have continued, and therefore it is a pixel that is stored at the end of the line memory 23 when the pixel is found.

However, as a matter of convenience, it is possible to regard a pixel that is stored in the buffer memory 22 at that time as the end pixel.

Then, after the end pixel, if a pixel having a difference within a predetermined range is found again, addresses of a first pixel and an end pixel are stored in the edge address memory portion 27 in the same process as described above.

In this way, the edge address memory portion 27 stores a plurality sets of a starting address ADS and an ending address ADE of the first pixel and the end pixel for each of the detected sets in the same line.

The lateral area setting portion 26 sets a predetermined range for the comparison in the lateral comparison portion 25. The lateral comparison portion 25 performs the comparison based on the range set in the lateral area setting portion 26. The lateral area setting portion 26 stores values indicating a maximum value of a difference of the luminance value, e.g., “20”, “10” or “6” as a value indicating the range. In addition, if detection is performed only in the case where the difference is zero that means they are identical to each other, “0” is stored as the difference of the luminance value.

The edge address memory portion 27 stores the address of the edge YE detected by the lateral comparison portion 25 as described above. In other words, the edge address memory portion 27 stores the starting address ADS and the ending address ADE. Note that it is possible to configure so that only X addresses of the starting address ADS and the ending address ADE are stored. In addition, it is possible to configure so that together with the starting address ADS and the ending address ADE, pixel data SD thereof is stored.

The lateral address comparison portion 28 compares the starting address ADS and the ending address ADE stored in the edge address memory portion 27 with the address ADT of the center pixel in the temporary memory 24 concerning the X address. When the address ADT matches either the starting address ADS or the ending address ADE about the X address, a matching signal SA is outputted to the vertical comparison portion 29.

The vertical comparison portion 29 regards each pixel of the addresses ADS and ADE stored in the edge address memory portion 27 as the noted pixel, so as to compare the pixel data SD of the noted pixel with that of a pixel neighboring the noted pixel in the next line. If a difference between them is within a predetermined range, the pixel GS is detected as an area edge RE.

More specifically, the vertical comparison portion 29 regards the center pixel GS stored in the temporary memory 24 as the noted pixel so as to compare it with a pixel GS one line later stored in the buffer memory 22.

Then, it checks whether or not the difference between the pixel data SD is within a predetermined range. If the difference is within a predetermined range and the matching signal SA is outputted from the lateral address comparison portion 28, the address of the center pixel stored in the temporary memory 24 and the address of the pixel in the buffer memory 22 are stored as the area edge addresses in the area address memory portion 31. At the same time, a pixel data SD of the corresponding pixel GS is also stored in the area address memory portion 31.

The vertical comparison portion 29 performs this process in series about the addresses ADS and ADE stored in the edge address memory portion 27. Then, the address of the pixel in the buffer memory 22 is stored in series in the area address memory portion 31.

Note that although the center pixel stored in the temporary memory 24 is regarded as the noted pixel, it is possible to regard the pixel stored in the buffer memory 22 as the noted pixel.

In addition, the matching signal SA from the lateral address comparison portion 28 is a condition for the determination performed by the vertical comparison portion 29. This added condition enables to prevent a pixel that is not the lateral direction edge from being included as the pixel of the area edge RE so that a correct area edge RE can be detected.

When the center pixel GS stored in the temporary memory 24 is regarded as the noted pixel, pixels GS at both sides thereof may be compared with the pixel in the buffer memory 22. Then, if a difference between them is within a predetermined range, the corresponding pixel in the temporary memory 24 and the corresponding pixel in the buffer memory 22 are regarded as the area edge RE so that their addresses are stored in the area address memory portion 31.

In this case, if a plurality of pixels out of three pixels in the temporary memory 24 correspond to the area edge RE, the first pixel is regarded as the area edge RE when the starting address ADS is used, while the last pixel is regarded as the area edge RE when the ending address ADE is used. Thus, the outmost pixel in the area to be extracted is detected as the area edge RE.

As a result, a continuity of pixels GS in the vertical direction about a luminance value is checked for pixels GS of the addresses ADS and ADE stored in the edge address memory portion 27, and addresses of the pixels of the left and the right edge portions of the pixels having different luminance values from surrounding pixels, i.e., of the area edge RE, are stored in the area address memory portion 31. In other words, the area edge RE shows a two-dimensional image area.

The vertical area setting portion 30 sets a predetermined range for the comparison performed by the vertical comparison portion 29. The vertical comparison portion 29 performs the comparison in accordance with the range set in the vertical area setting portion 30. A value similar to the lateral area setting portion 26 described above is set in the vertical area setting portion 30. Note that different areas may be applied to three pixels stored in the temporary memory 24. For example, the center pixel may be assigned with a value that is larger as an area than pixels on both sides. In addition, the vertical area setting portion 30 may be set with a value that is different from the lateral area setting portion 26.

The area address memory portion 31 stores addresses and luminance values of the area edge RE that corresponds to vertical lines on both sides of a two-dimensional image area enclosed by continuous pixels in the lateral direction at a difference within a predetermined range and continuous pixels in the vertical direction at a difference within a predetermined range for the image GD of one frame as described above.

The area extraction portion 32 extracts an area that matches the size condition SJ stored in the size condition memory portion 33 as a predetermined image area GR from the area edge RE stored in the area address memory portion 31.

More specifically, the size condition memory portion 33 stores the size condition SJ of the image area GR to be detected. As the size condition SJ, a lateral size LY, a vertical size LT and an area value LM are stored as values within a predetermined range. It is possible to use the number of pixels as a predetermined value. If the area edge RE stored in the area address memory portion 31 matches these size conditions SJ, the area edge RE is extracted as a target image area GR, so that the address of the image area GR and the pixel data SD of each pixel GS included in the image area GR are outputted as the detection result KD. Note that all size conditions SJ may be applied or a part of the size conditions SJ may be applied.

The counter 34 controls an operational timing of each portion of the image detection device 5. The counter 34 counts clock signals included in the image data GD that is inputted on a pixel or bit basis from the camera 3, for example, so that a clock signal for the operation of each portion is outputted in accordance with a count value. Therefore, the address of each pixel to be stored in the buffer memory 22 or the temporary memory 24 is generated in accordance with the clock signal from the counter 34 and is used for each control and storage of a data.

In this way, according to the image detection device 5, an object to be detected such as an intruder can be detected at a high speed, and a load on the process that will be performed after that by the CPU or the like of the image processor 6 can be reduced.

Next, an operation of the image detection device 5 will be described in detail with reference to FIGS. 4 through 11. Note that there is a case where a structure or an operation in the following description is different from that in the above description. In this case, it can be considered as a variation of the structure or the operation of the image detection device 5.

In FIG. 4, the image GD1 outputted from the camera 3 includes a background area HR1 due to a background image and three object areas (image areas) BR1-BR3 due to object images having luminance values different from the background area HR1. The image detection device 5 extracts the object areas BR1-BR3 from the image GD1 and determines whether each of the object areas BR1-BR3 is the predetermined image area GR matching the size condition SJ.

If it is determined to be the image area GR, it is outputted to the image processor 6 as the detection result KD.

The image processor 6 analyzes objects included in each image area GR in detail, for example, whether or not each of the objects is an intruder. If it is determined to be an intruder, a warning signal or the like is outputted.

If there is an intruder SN in the area shot by the camera 3 as shown in FIG. 5(A), an image GD2 includes an image area GG1 that is made up of pixels corresponding to the intruder SN having luminance values different from those of pixels GS surrounding the image area GG1 as shown in FIG. 5(B). The image detection device 5 detects this image area GG1 to be the area edge RE, and the address thereof is stored in the area address memory portion 31. If the image area GG1 matches the size condition SJ, it is extracted as a target image area GR.

In FIG. 6, as the image data GD3, for each line having the Y address of y0, y1 or y2, the pixel data SD of each pixel GS is indicated as A1, A2, A3, . . . or the like. In FIG. 7, in the image detection device 5 that is performing the image data GD3, a storage state of the data at a certain timing is shown.

In FIG. 7, the buffer memory 22 stores a pixel data “B5” of the address (Xx2, Yy1). The line memory 23 stores pixel data “B4”, “B3”, “B2”, “B1”, “An”, . . . , “A7” of one line before. The temporary memory 24 stores three pixel data “A6”, “A5” and “A4” before the pixel stored in the line memory 23.

Note that before this state, as a result of a process that had been performed for a line of the Y address y0, X addresses “x1”, “x2”, “x3”, “x4”, . . . “x1”, of pixels detected as the edge YE are stored in the edge address memory portion 27. The last “x1” is the starting address ADS of the first edge YE of a line having the Y address y1.

In addition, addresses (x1, y0), (x2, y0) and (x1, y1) of pixels detected as the area edge RE are stored in the area address memory portion 31. The last (x1, y1) corresponds to starting address ADS “x1” of the first edge YE for the line having the Y address y1, which was detected and stored as the area edge RE.

The pixel data “B5” stored in the buffer memory 22 is compared with the pixel data “B4” stored at the end of the line memory 23. If a difference between them is within a predetermined range, it is detected to be in the middle of the continuing pixels, and it is not stored in the edge address memory portion 27. If the difference is not within the predetermined range, it is detected to be the end of the continuing pixels having a luminance value “B4”, and an X address thereof is stored in the edge address memory portion 27 as the ending address ADE.

In addition, at the same time, the pixel data “B5” stored in the buffer memory 22 is compared with the pixel data “A6”, “A5” and “A4” stored in the temporary memory 24. If a difference between them is within a predetermined range, it is detected to be the area edge RE continuing in the vertical direction, and an address of the pixel of “B5” is stored in the area address memory portion 31.

Note that the X addresses “x1” of the starting address ADS and the X addresses “x2” of the ending address ADE stored in the edge address memory portion 27 are compared with the address “xA5” of the center pixel in the temporary memory 24 by the lateral address comparison portion 28. Since the address “x2” matches the address “xA5”, the matching signal SA is sent to the vertical comparison portion 29. This matching signal SA makes the comparison result effective in the vertical comparison portion 29, and only the edge YE continuing in the vertical direction for the edge YE is detected.

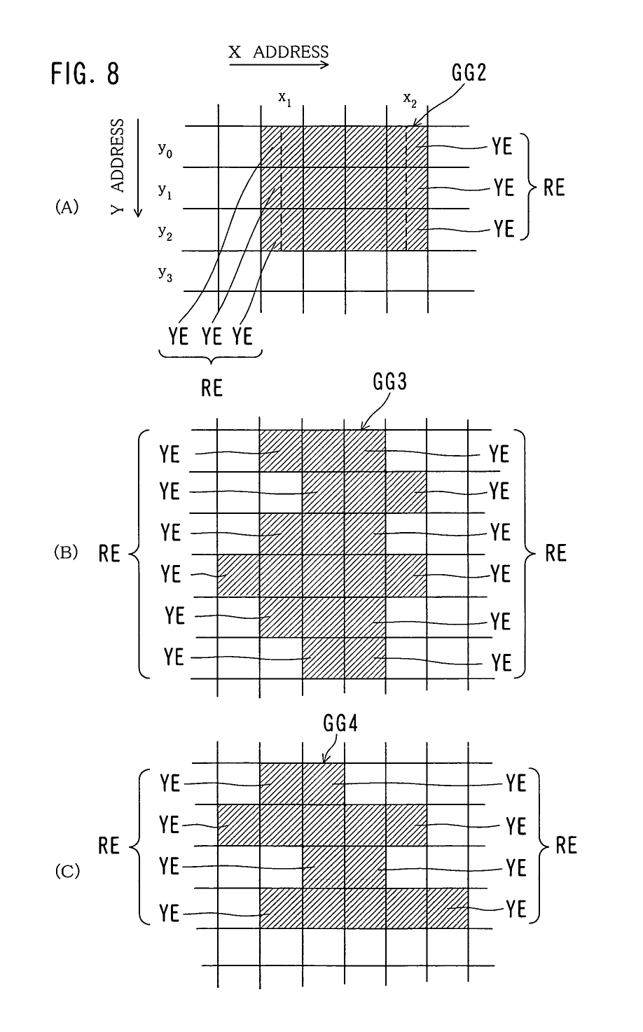

In this way, a sequential process is performed on the inputted image data GD. As a result, the image area GG2 is detected, in which the X address continues from “x1” to “x2” in the lateral direction, and the Y address continues from “y0” to “y2” in the vertical direction as shown in FIG. 8(A), for example.

In FIG. 8(A), the rectangular image area GG2 shown with hatching has the area edge RE detected by the vertical comparison portion 29 in accordance with the edge YE detected by the lateral comparison portion 25. The addresses of pixels on this area edge RE are accumulated in the area address memory portion 31 as the area edge address.

In addition, as shown in FIG. 8(B), the image area GG3 that is not rectangular is also detected. More specifically, the image area GG3 includes pixels on the area edge RE having lateral direction positions that are different from each other between lines, and the vertical comparison portion 29 detects such an image area GG3, too.

In addition, in the example described above, three pixels are stored in the temporary memory 24 and compared with one pixel in the buffer memory 22. However, it is possible to configure so that more pixels are stored in the temporary memory 24, and even if there is a difference of two pixels or more between lines in the lateral direction, they are regarded as continuous to be detected as the area edge RE. Further, in this case, it is possible to adopt a method of storing a plurality of pixels in the buffer memory 22 instead of storing more pixels in the temporary memory 24 so as to compare them with each other, or other method.

The image area GG4 shown in FIG. 8(C) has positions of pixels in the lateral direction on the area edge RE that are different from each other between lines, and the difference is two pixels. The vertical comparison portion 29 can detect such an image area GG4, too. It can also detect the image area GG1 shown in FIG. 5(B).

Then, if each of the image areas GG1-GG4 matches the size condition SJ, it is detected to be a predetermined image area GR.

For example, if the number of pixels in the lateral direction and the vertical direction in the image area GG is within the range of the lateral size LY and the vertical size LT set as the size condition SJ, it is detected as a predetermined image area GR. Alternatively, if it is within a range of the area value LM, it is detected as a predetermined image area GR. If the image area GG is not rectangular, a rectangular area including the image area GG is supposed, or straight lines located on average positions of pixels located on the outmost position of the image area GG and a rectangular area defined by the straight lines is supposed. Then, the size condition SJ may be applied to the supposed rectangular area.

In addition, an area value is determined directly from the number of pixels in the image area GG and it is checked whether or not the area value is within the range of the area value LM. For example, if the area value of the image area GG is Z, and the range of the area value LM is from α to β, the condition α<Z<β is checked. If this condition is satisfied, it is determined to be an image area GR or an intruder SN.

According to this process, for example, the object areas BR1 and BR2 shown in FIG. 4 are extracted as the image area GR since they satisfy the size condition SJ. However, the image area BR3 is not extracted as the image area GR since it has a small area value and does not satisfy the size condition SJ. Such a detection result KD is obtained. In addition, there is a case where another detection result KD is obtained, which shows that the object area BR2 is not extracted as the image area GR since it is too large to comply with the size condition SJ.

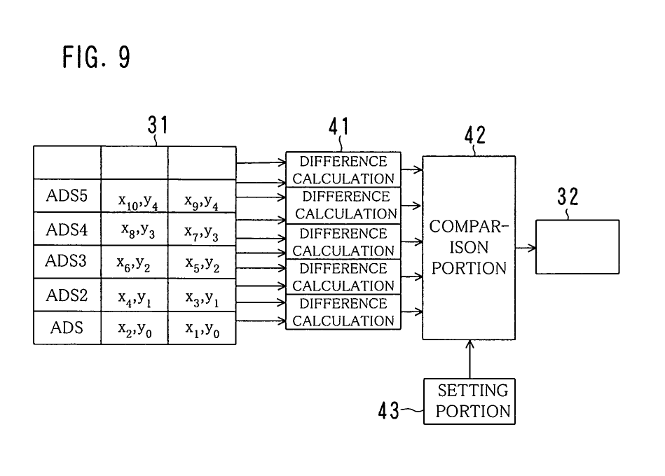

In addition, as shown in FIG. 9, a difference calculation portion 41 is provided for calculating a difference between addresses of lines of the area edges RE stored in the area address memory portion 31. Further, a comparison portion 4 is provided for comparing differences calculated by the difference calculation portion 41. The comparison portion 42 detects whether the area edge RE is a straight line or a curved line in accordance with the result of comparison. In accordance with the detection result, the area extraction portion 32 extracts ones that satisfy a predetermined condition.

More specifically, a difference of positions in the lateral direction between pixels on the area edge RE, which is a shift of the position of the pixels in the lateral direction between lines, is determined as a difference by the difference calculation portion 41. If the shifts are the same as each other, it is detected that the area edge RE is on a vertical or a diagonal straight line. This is included in a part of the size condition SJ for determination. For example, if the area edge RE is like a straight line, it is determined to be an image area GR. Alternatively, if the area edge RE is like a zigzag shape, it is determined to be an image area GR. In this way, in accordance with a purpose of the detection, an unnecessary image area GG or object area BR can be eliminated for narrowing.

In addition, in accordance with the shift of the position of the pixel in the lateral direction between lines, it is detected whether or not the area edge RE is curved. For example, a part that is bent more than a predetermined degree is detected as a curve. In addition, a part that is bent less than or equal to the predetermined degree is detected as a straight line. A range of the predetermined degree is preset in the setting portion 43. Including this detection result, the area extraction portion 32 determines whether or not to be the image area GR. Thus, even if a distortion is generated due to reflection of light on the object, an error in detection can be prevented.

In the example described above, the image area GR is detected in the one frame image GD obtained by the camera 3. However, it is possible to configure so that the image area GR is detected in accordance with an image GD of a plurality of frames.

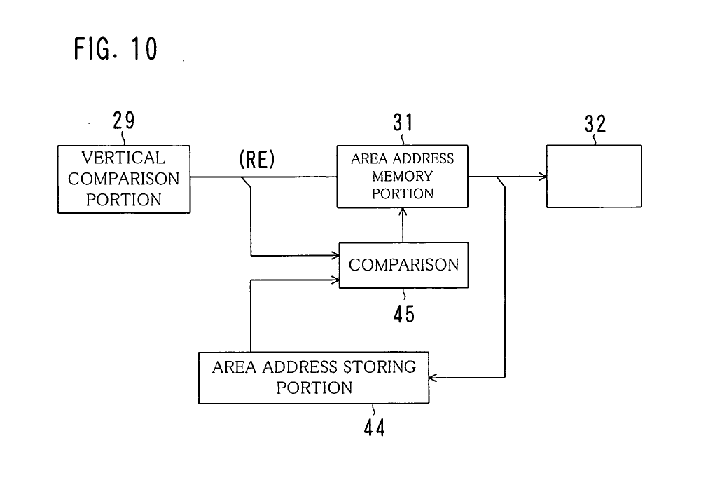

For example, as shown in FIG. 10, concerning the area edge RE of the previous one frame detected by the vertical comparison portion 29, the address thereof is stored in the area address storing portion 44. The area edge RE detected by the vertical comparison portion 29 is compared by the comparison portion 45 with the area edge RE stored in the area address storing portion 44, and only the area edge RE that is not stored in the area address storing portion 44 is stored in the area address memory portion 31.

In this way, only a difference of the area edge RE between frames is extracted as the image area GR, and the same area edge RE that is detected for each frame is not extracted as the image area GR. Thus, buildings and trees or other objects that has no relationship with an intruder SN can be eliminated from the detection result KD, so that only a required image can be detected.

In addition, an address of the detected area edge RE is stored in the area address storing portion 44 for a preset time period. Then, the area edge RE to be detected by the vertical comparison portion 29 is compared with the area edge RE stored in the area address storing portion 44, so that only an area edge RE existing for the preset time is extracted. Thus, only the area edge RE moving at a low speed within a predetermined range between frames is extracted as the image area GR. In addition, even if the original image data to be a background alters due to a way that the objects are lighted, only an image that is required actually can be detected by comparing the data between frames or for a predetermined time period.

In addition, the area address storing portion 44 stores area edges RE of a plurality of frames, the area edge RE that is detected by the vertical comparison portion 29 is compared with the area edge RE stored in the area address storing portion 44 by the comparison portion 45, so that a moving speed of the area edge RE is calculated. The moving speed can be calculated from a shift of a position of the area edge RE between frames and a time of one frame. In this case, the comparison portion 45 corresponds to a speed calculation portion in the present invention.

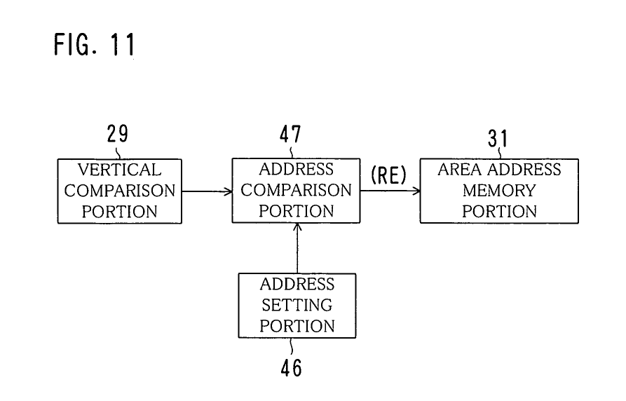

In addition, in order not to perform the detection in an unnecessary area, it is possible to set an area to be detected (a target area) in the image GD. For example, as shown in FIG. 11, an address setting portion 46 and an address comparison portion 47 may be provided, an address of the pixel in the temporary memory 24 or an address of the area edge RE detected by the vertical comparison portion 29 is compared by the address comparison portion 47, and the address of the area edge RE is stored in the area address memory portion 31 only if it is within a predetermined range. An address indicating an area to be detected is preset in the address setting portion 46, and the address comparison portion 47 performs the comparison in accordance with the preset address. Thus, the detection is not performed in an unnecessary area in the image GD, so that a quantity of data to be stored in the area address memory portion 31 can be reduced.

For example, if a boundary portion of a certain ground is included in the area shot by the camera 3, objects located in front of the ground is omitted from targets to be detected so that only objects on the far side of the ground or on the boundary can be detected.

Note that the address setting portion 46 corresponds to a target area setting portion in the present invention.

In addition, it is possible to set so that the area to be detected matches a specific object included in the image GD. For example, if a fence is included in the image GD, a range including the fence is set as the area to be detected. Then, a data of the area to be detected for the previous one frame is accumulated, so that the accumulated data is compared with the current data. In accordance with a comparison result, it is determined whether or not it is an intruder SN. In addition, it can be determined whether the intruder SN exists on the far side of the fence or has intruded over the fence into the near side of the fence.

According to the embodiments and variations described above, an image area GR matching a predetermined condition can be detected from an image obtained from various monitored areas. For example, it is possible to monitor a floodgate in a river or the like. In this case, it is possible to monitor only a vicinity of the upstream side of the floodgate or to detect only large objects that cannot pass the floodgate without extracting small objects that pass the floodgate.

In the embodiment described above, the configuration, the structure, the shape or the dimension of a whole or a part of the monitoring processor 4, the image detection device 5 or the monitoring system 1, or the number of them, contents of the image, the timing or the like can be modified in accordance with a spirit of the present invention, if necessary.

Although the embodiment of the present invention is described above with several examples, the present invention is not limited to the embodiment described above but can be embodied in various ways.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. An image detection device for detecting a predetermined image area from an image data that is inputted in series for each pixel of an image made up of a plurality of pixels arranged in a lateral direction and a vertical direction like a matrix, the device comprising:
a size condition memory portion for storing a size condition of the image area to be detected;
a lateral direction edge detection portion for detecting an edge by comparing pixel data of neighboring pixels on one line in the lateral direction of the image;
an edge address memory portion for storing an address of the detected edge;
a vertical direction detection portion for regarding each pixel of the address stored in the edge address memory portion as a noted pixel, comparing a pixel data of the noted pixel with that of a pixel on the next line neighboring the noted pixel and detecting a pixel having a difference of the pixel data within a predetermined range;
an area address memory portion for storing an address of the detected pixel as an area edge address when it is detected that the difference of the pixel data is within a predetermined range by the vertical direction detection portion; and
an area extraction portion for extracting an area that satisfies the size condition stored in the size condition memory portion from an area address stored in the area address memory portion.

2. The image detection device according to claim 1, wherein the lateral direction edge detection portion regards one of pixels inputted in series as the noted pixel, compares the pixel data of the noted pixel with that of a pixel neighboring the noted pixel, and detects pixels at both ends of consecutive pixels having the difference within a predetermined range as the edge.

3. The image detection device according to claim 1, wherein the vertical direction detection portion compares three pixels with each other, the three pixels including a pixel on the next line of the noted pixel at the same position in the lateral direction as the noted pixel and pixels on both sides of the pixel.

4. The image detection device according to claim 1, further comprising a line memory for delaying the inputted image data by one line, wherein the vertical direction detection portion obtains the pixel data of the noted pixel from the image data delayed by the line memory.

5. The image detection device according to claim 1, wherein the size condition is a condition about a vertical size and a lateral size of a rectangular image area.

6. The image detection device according to claim 1, wherein the size condition includes a condition about an area value of the image area, and the area extraction portion determines the area value from the area address stored in the area address memory portion so as to extract an area having the determined area value that satisfies the size condition.

7. The image detection device according to claim 5, wherein the size condition includes a permissible range of the vertical size, the lateral size or the area value.

8. The image detection device according to claim 1, wherein the area address memory portion is capable of storing the area edge address of a plurality of images that are consecutive, a speed calculation portion is provided for determining a moving speed of an area specified by the area edge address in accordance with the area edge address of the plurality of images, and the area extraction portion extracts only an area having the moving speed determined by the speed calculation portion within a predetermined range.

9. The image detection device according to claim 1, wherein the area extraction portion extracts only an area of the area edge address that was detected newly in the plurality of images.

10. The image detection device according to claim 1, further comprising a target area setting portion for setting a target area within the image, and the area extraction portion extracts only an area within the target area set by the target area setting portion.

11. An image detection device for detecting a predetermined image area from an image data that is inputted in series for each pixel of an image made up of a plurality of pixels arranged in a lateral direction and a vertical direction like a matrix, the device comprising:
a size condition memory portion for storing a size condition of the image area to be detected;
a buffer memory for storing a pixel data for one pixel of the inputted image data;
a line memory for delaying the inputted pixel data by one line;
a temporary memory for storing a pixel data of a pixel that is delayed by one line from the pixel stored in the buffer memory when it is delayed by the line memory;
a lateral direction edge detection portion for detecting an edge in the lateral direction by comparing the pixel data stored in the buffer memory with a pixel data of a pixel neighboring in the lateral direction;
an edge address memory portion for storing an address of the detected edge;
a vertical direction detection portion for comparing the pixel data stored in the buffer memory with the pixel data stored in the temporary memory, and detecting a pixel having a difference between the pixel data that is within a predetermined range;
an area address memory portion for storing an address of the detected pixel as an area edge address when it is detected that the difference of the pixel data is within the predetermined range by the vertical direction detection portion; and
an area extraction portion for extracting an area that satisfies the size condition stored in the size condition memory portion from an area address stored in the area address memory portion.

12. The image detection device according to claim 11, wherein the area address memory portion stores the address of the detected pixel as the area edge address only when it matches the address stored in the edge address memory portion or an address in the vicinity thereof in the vertical direction detection portion.
